(19) United States
(12) Patent Application Publication
(10) Pub. No.: US 2025/0378631 A1
(43) Pub. Date: Dec. 11, 2025

(54) ESCAPED RENDERING OF EMBEDDED MEDIA

(71) Applicant: Apple Inc., Cupertino, CA (US)

(72) Inventor: Jeremy G Bridon, Mountain View, CA (US)

(21) Appl. No.: 19/211,526

(22) Filed: May 19, 2025

Related U.S. Application Data
(60) Provisional application No. 63/657,327, filed on Jun. 7, 2024.

(51) Int. Cl. G06T 15/20; G06T 5/70; G06T 11/00; G06T 15/40

(52) U.S. Cl. CPC G06T 15/205; G06T 5/70; G06T 11/001; G06T 15/40; G06T 2200/24; G06T 2207/20016; G06T 2207/20021; G06T 2210/36

(57) ABSTRACT

Various implementations disclosed herein include devices, systems, and methods that separate multi-layer/multi-resolution content for rendering. For example, a process may obtain obtaining multi-layer content comprising a first layer of content and one or more second layers of content having a resolution differing from a resolution of the first layer of content. The process may further separate the first layer of content of the multi-layer content thereby providing a remaining portion of the multi-layer content for rendering. The process may further render a view of a 3D environment including a depiction of the multi-layer content at a 3D position within the 3D environment. The depiction of the multi-layer content may be rendered by blending the separated first layer of content and the texture of the remaining portion of the multi-layer content.

### CROSS-REFERENCE TO RELATED APPLICATIONS

This application claims the benefit of U.S. Provisional Application Ser. No. 63/657,327 filed Jun. 7, 2024, which is incorporated herein in its entirety.

### TECHNICAL FIELD

The present disclosure generally relates to systems, methods, and devices that obtain and render multi-layer/multi-resolution content for viewing via electronic devices, such as head-mounted devices (HMDs).

### BACKGROUND

Existing techniques for rendering a single two-dimensional (2D) texture for multi-layer content to appear at a three-dimensional (3D) position in a view of a 3D environment may be improved with respect to resolution, warping issues and other defects associated with high resolution content.

### SUMMARY

Various implementations disclosed herein include devices, systems, and methods that render multi-layer content that includes a high-resolution layer and low-resolution layers within a 3D environment such as, inter alia, an extended reality (XR) environment. For example, a high-resolution layer may include content such as, inter alia, video content, image content, additional display content, etc. Likewise, a low-resolution layer may include content such as, inter alia, a webpage surrounding high-resolution content, a video player, a user interface (UI) and associated elements, etc.

In some implementations, multi-layer content including a high-resolution content layer and low-resolution content layers may be obtained (e.g., via an HMD). In some implementations, the high-resolution content layer may be separated from the from the rest of the multi-layer content for fragment shader rendering as separate items rather than as a single texture. In some implementations, the high-resolution content layer may be separated from the rest of the multi-layer content to preserve a resolution of a high-resolution content layer during fragment shader rendering.

In some implementations, multi-layer content resulting from the separation may be altered to simplify shader rendering. For example, simplifying shader rendering may allow a shader (e.g., a module running on a graphical processing unit (GPUI) configured to control pixel rendering) to circumvent the need to use z/depth information to distinguish portions of high-resolution video content that should be visible from low-resolution/UI content located over the high-resolution video content. Therefore, areas of low-resolution/UI content located behind the high-resolution video content (e.g., in z depth) may be removed from the low-resolution layer so that when a shader renders the low-resolution content in front of the high-resolution video content, appropriate portions of the high-resolution video content are visible. For example, a video may be visible at all locations except at a location that includes UI elements located in front of the high-resolution video content.

In some implementations, a user may have a peripheral view of the video causing a single large fragment including multiple pixels to land on an edge area located between a video texture and a UI texture. Therefore, the fragment may be computed with partial coverage of a video texture and a partial coverage of the UI texture. In this instance, a sampler may be instructed to perform sampling functions at a location that is further away from the edge area.

In some implementations, the aforementioned shader rendering process may be disabled during specific circumstances such as, inter alia, instances where there is a blurred UI-on-video, instances where a video has scrolled out of an interface, instances of specified types of transparent video, etc.

In some implementations, an HMD has a processor (e.g., one or more processors) that executes instructions stored in a non-transitory computer-readable medium to perform a method. The method performs one or more steps or processes. In some implementations, the HMD obtains multi-layer content comprising a first layer of content and one or more second layers of content. The first layer of content may have a resolution that is different than the one or more of the second layers of content. In some implementations, the first layer of content is separated from the multi-layer content. Separating the first layer provides a remaining portion of the multi-layer content. In some implementations, a texture of the remaining portion of the multi-layer content is rendered and a view of a 3D environment that includes a depiction of the multi-layer content at a 3D position within the 3D environment is rendered. The depiction of the multi-layer content may be rendered by blending the separated first layer of content and the texture of the remaining portion of the multi-layer content.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-B illustrate exemplary electronic devices operating in a physical environment in accordance with some implementations.

FIGS. 2A-2C illustrate views representing multilayer content rendering that includes a high-resolution content layer and low-resolution layers within an 3D environment, in accordance with some implementations.

FIGS. 3A-3C illustrate views representing a fragment(s) that includes multiple pixels, in accordance with some implementations.

FIG. 4 is a flowchart representation of an exemplary method that separates high-resolution layer content from multi-layer content for fragment shader rendering as separate items, in accordance with some implementations.

FIG. 5 is a block diagram of an electronic device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

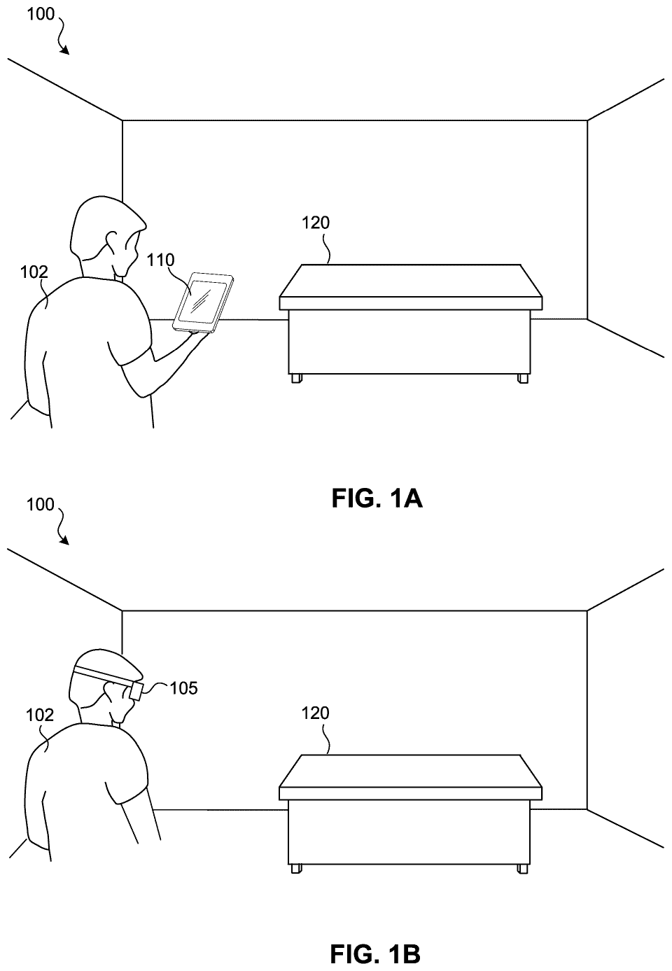

FIGS. 1A-B illustrate exemplary electronic devices 105 and 110 operating in a physical environment 100. In the example of FIGS. 1A-B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user 102 within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that are generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, an HMD (e.g., device 105) may be configured to render multi-layer content that includes a high-resolution layer (e.g., video content) and low-resolution layers (e.g., a webpage surrounding high-resolution content, a video player, etc.) within a 3D environment (e.g., an XR environment).

In some implementations, an HMD may be configured to obtain multi-layer content that includes a first layer of content such as, inter alia, video content and at least one second layer of content such as, inter alia, layers that define UI elements. In some implementations, the first layer of content may have a resolution that is different than a resolution the at least one second layer of content. For example, the first layer of content may have a higher resolution than a resolution of the at least one second layer of content.

In some implementations, the first layer of content of the multi-layer content may be separated such that a portion of the multi-layer content remains. For example, background content located behind video content may be removed such that the video content will be visible within a view of a 3D environment without having to account for depth (e.g., via a shader).

In some implementations, a texture of remaining portion of the multi-layer content may be rendered. For example, a layer compositing engine may be configured to composite any remaining layers into a single texture.

In some implementations, a view of a 3D environment that includes a depiction of the multi-layer content may be rendered at a 3D position within the 3D environment. In some implementations, the depiction of the multi-layer content may be rendered by blending the separated first layer of content and the texture of the remaining portion of the multi-layer content. For example, a shader may render low-resolution content in front of high-resolution content such that appropriate portions of the high-resolution content are visible.

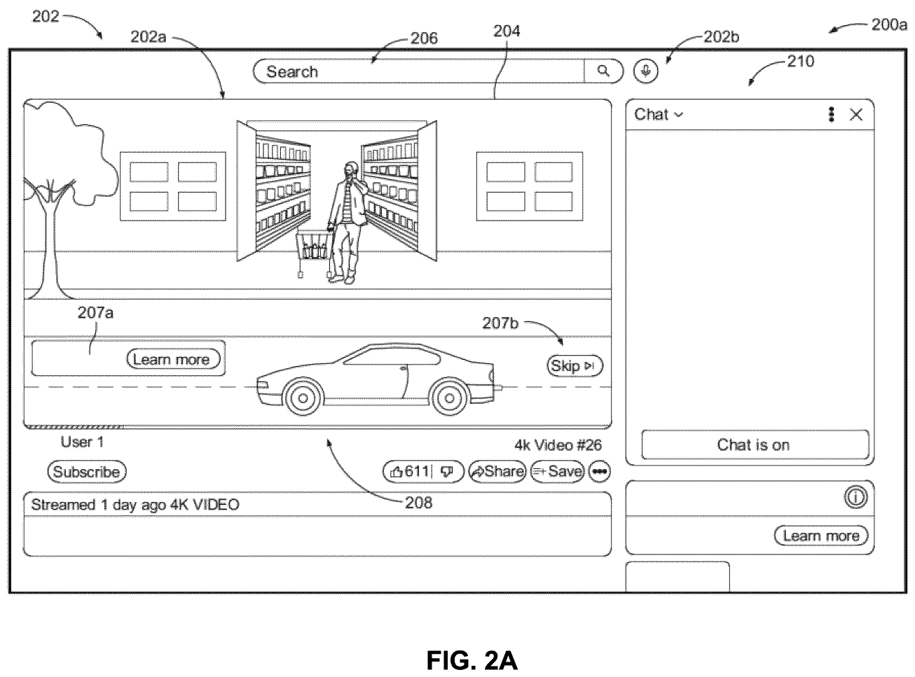

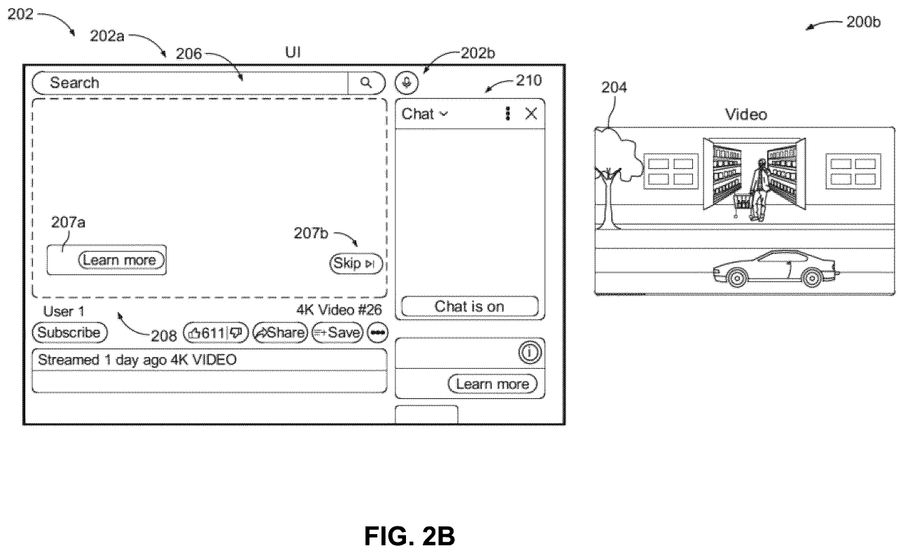

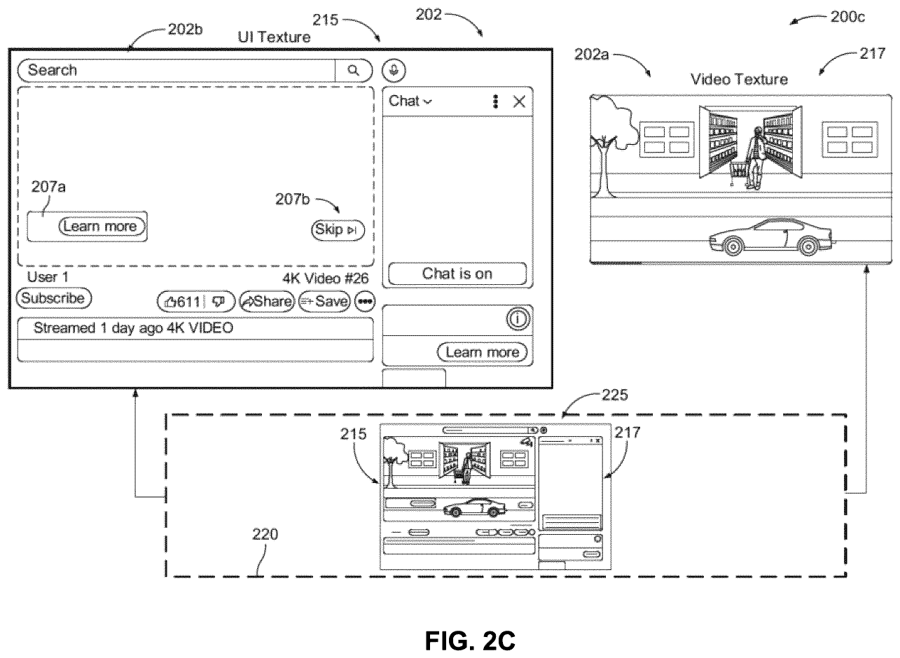

FIGS. 2A-2C illustrate views 200a, 200b, and 200c representing multilayer content rendering that includes a high-resolution content layer (e.g., video, images, etc.) and low-resolution layers (e.g., a surrounding webpage, video player, UI elements, etc.) within an 3D environment, in accordance with some implementations.

FIG. 2A illustrates view 200a representing multilayer content 202 (e.g., a Webpage) that includes a high-resolution content layer 202a and a low-resolution content layer(s) 202b. For example, the high-resolution content layer 202a includes a high-resolution video 204. Likewise, the low-resolution content layer(s) 202b includes a surrounding webpage 206 (comprising Webpage content 210) and a video player 208 with overlaying content 207a and 207b (e.g., a video description or rating, video player control buttons, etc.). View 200a illustrates high-resolution content and low-resolution content being rendered as a single 2D texture having a consistent resolution that is subsequently rendered to appear at a 3D position in a view of a 3D environment thereby potentially resulting in a resolution loss, warping, or additional defects (e.g., due to high-resolution video 204 being stretched) within the high-resolution content. Therefore, the high-resolution content layer 202a may be separated from the rest of the multi-layer content (e.g., low resolution content layer 202a) for fragment shader rendering as separate items rather than a single texture (preserving high resolution video 204) as further described with respect to FIGS. 2B-2C, infra.

Likewise, a resolution of multi-layer content 202 may be dependent on an angle and distance from a user as well as a gaze direction due to, for example, foveation thereby potentially requiring multiple iterations of up-sampling and down-sampling of the multi-layer content 202. Therefore, the high-resolution content layer 202a may be separated from the rest of the multi-layer content (e.g., escaping a video texture) to improve a resampling process to a final resolution size by, for example, using a different sampling technique, avoiding intermediate/multiple resampling processes, etc.

FIG. 2B illustrates view 200b representing multilayer content 202 (e.g., as illustrated in FIG. 2A) that has been processed such that high-resolution content layer 202a (e.g., high-resolution video 204 for rendering as a video texture) has been separated from low-resolution content layer(s) 202b (e.g., the rest of the multi-layer content 202 for rendering as a UI texture). The high-resolution content layer 202a includes a high-resolution video 204 for independently rendering as a video texture. Likewise, low-resolution content layer(s) 202b includes surrounding webpage 206 (comprising Webpage content 210) and video player 208 with overlaying content 207a and 207b for independently rendering as a UI texture.

In some implementations, separating high-resolution content layer 202a from low-resolution content layer(s) 202b may include removing layer content (e.g., from one or more of low-resolution content layer(s) 202b) that is located behind high-resolution content layer 202a. For example, any background content located behind high resolution video 204 may be removed such that high resolution video 204 may be visible within a view of a 3D environment without a shader having to account for depth information.

FIG. 2C illustrates view 200c representing low-resolution content layer(s) 202b combined into a single UI texture 217 and high-resolution content layer 202a represented as a single video texture 215.

View 200c additionally represents a view of a 3D environment 220 being rendered for viewing via a device such as an HMD. The view of 3D environment 220 includes a depiction of blended multi-layer content 225 placed at a 3D position within 3D environment 220. In some implementations, the depiction of multi-layer content 225 may be rendered by blending video texture 215 and UI texture 217. For example, a shader may be configured to render content low-resolution content layer(s) 202b in front of content of high-resolution content layer 202a such that associated portions of the content of high-resolution content layer 202a (e.g., video) are visible with the exception of locations that are associated with UI elements (in front) such video player buttons, notifications, video ratings, etc.

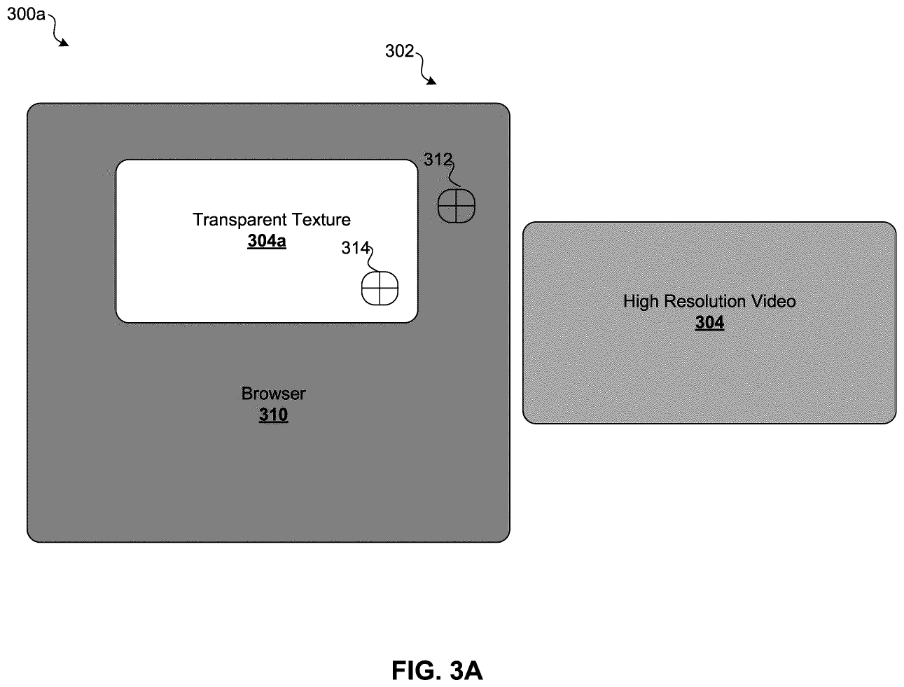

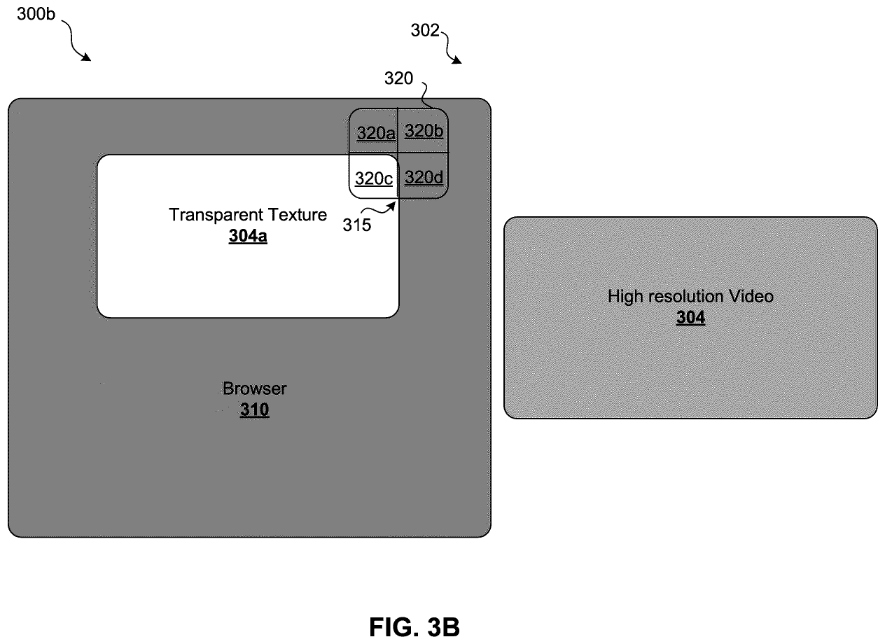

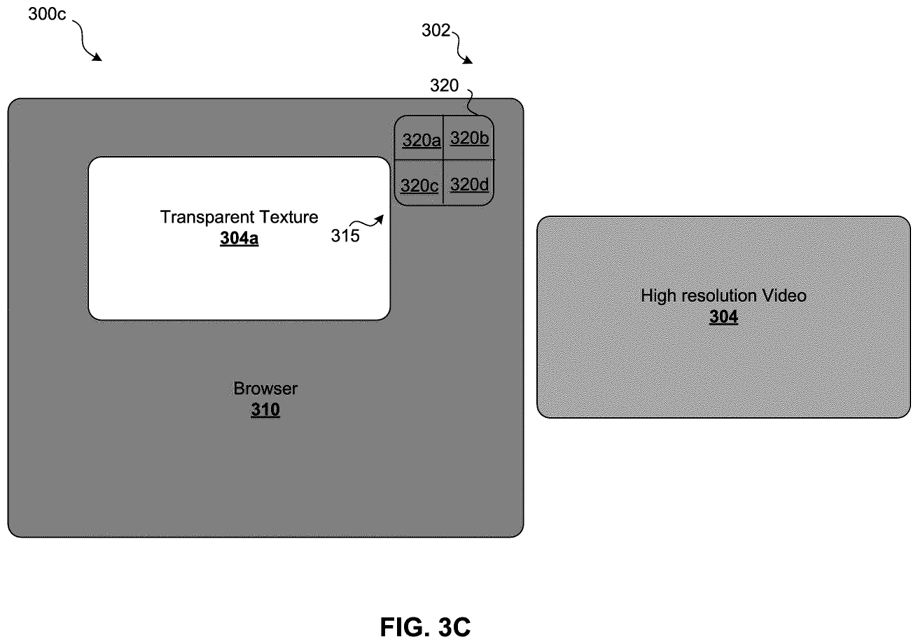

FIGS. 3A-3C illustrate views 300a, 300b, 300c representing a fragment(s) that includes multiple pixels, in accordance with some implementations.

FIG. 3A illustrates view 300a representing multilayer content 302 (e.g., as illustrated in FIG. 2A) that has been processed such that a high-resolution video layer 304 (for rendering as a video texture with respect to a transparent texture 304a) has been separated from a browser (low-resolution content) layer(s) 310 for rendering as a UI texture (opaque texture).

View 300a illustrates, a user having a direct view (e.g., directly in front of the user) of high-resolution video 304. In this instance, a fragment that is resolving will be smaller than a texel (e.g., texel 312 or 314) and therefore the texel will be sampled with respect to only a portion of the transparent texture 304a (e.g., texel 314) or a portion of the opaque texture of browser 310 (e.g., texel 312).

FIG. 3B illustrates view 300b representing multilayer content 302 that has been processed such that a high-resolution video layer 304 (for rendering as a video texture with respect to a transparent texture 304a) has been separated from a browser (low-resolution content) layer(s) 310 for rendering as a UI texture (opaque texture).

View 300b illustrates a user having a peripheral view of high-resolution video 304 thereby causing a single large texel 320 (comprising portions 320a-320d) to land on an edge area 315 located between the transparent texture 304a or a portion of the opaque texture of browser 310. In this instance, a fragment may be computed with partial coverage of transparent texture 304a (e.g., portion 320c) and partial coverage of the opaque texture of browser 310 (e.g., portions 320a, 320b, and 320d). Therefore, the partial coverage issues may be resolved instructing a sampler to perform sampling functions at a location that is further away from the edge area 315 thereby enabling all portions 320a-320d of texel 320 to be located on the transparent texture 304a or the opaque texture of browser 310 as illustrated in FIG. 3C, infra.

FIG. 3C illustrates view 300c representing all portions 320a-320d of texel 320 located on the opaque texture of browser 310 in response to sampling functions being performed with respect to only the opaque texture of browser 310 in response to being moved away from the edge area 315 as described with respect to FIG. 3B, supra.

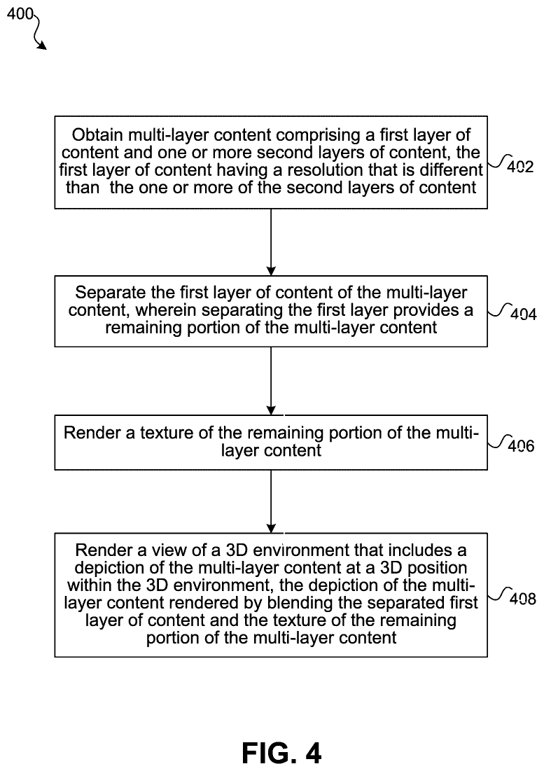

FIG. 4 is a flowchart representation of an exemplary method 400 that separates high-resolution layer content from multi-layer content for fragment shader rendering as separate items, in accordance with some implementations. In some implementations, the method 400 is performed by a device, such as a mobile device, desktop, laptop, HMD, or server device. In some implementations, the device has a screen for displaying images and/or a screen for viewing stereoscopic images such as a head-mounted display (HMD such as e.g., device 105 of FIG. 1). In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 402, the method 400 obtains multi-layer content comprising a first layer of content and one or more second layers of content. The first layer of content may have a resolution that is different than the one or more of the second layers of content. In some implementations, the first layer of content may include a higher resolution than a resolution of the one or more second layers of content. For example, multilayer content 202 (e.g., a Webpage) may include a high-resolution content layer 202a and a low-resolution content layer(s) 202b as described with respect to FIG. 2A, supra.

In some implementations, the first layer of content is a video layer.

In some implementations, the one or more second layers of content may define UI elements.

At block 404, the method 400 separates the first layer of content of the multi-layer content to provide a remaining portion of the multi-layer content. For example, multilayer content 202 may been processed such that a high-resolution content layer 202a (e.g., high-resolution video 204 for rendering as a video texture) has been separated from a low-resolution content layer(s) 202 as described with respect to FIG. 2B.

In some implementations, separating the first layer of content may be performed in response to determining that a criteria (e.g., blurred UI-on-video, a video being scrolled external to boundary of a media player window, etc.) has not been detected.

In some implementations, the criteria may identify that a blur effect is to be applied on the one or more of the second layers of content covering at least a portion of the first layer.

In some implementations, the criteria identifies that a portion of the first layer of content (e.g., a portion of a video) has exceeded a boundary of a presentation structure (e.g., has scrolled outside of a window of a media player).

In some implementations, a view of the 3D environment may be rendered with an initial configuration of the multi-layer content occurring prior to separating the first layer of content in response to determining that a criteria has been detected.

In some implementations, separating the first layer of content may include removing layer content from the one or more second layers. The layer content may be located behind the first layer of content.

In some implementations, removing the layer content from the one or more second layers may include removing background content located behind the first layer (e.g., video) such that content of the first layer will be visible within the view of the 3D environment without a module performing rendering (e.g., a shader) having to account for depth attributes.

At block 406, the method 400 renders a texture of the remaining portion of the multi-layer content as illustrated in FIG. 2B. In some implementations, rendering the texture may include compositing the remaining portion into a single texture.

At block 408, the method 400 renders a view of a 3D environment that includes a depiction of the multi-layer content at a 3D position within the 3D environment. The depiction of the multi-layer content may be rendered by blending the separated first layer of content and the texture of the remaining portion of the multi-layer content as illustrated in FIG. 2C.

In some implementations, rendering the view may include rendering the content of the one or more second layers in front of the of first layer of content such that appropriate portions of the of first layer of content are visible.

In some implementations, it may be determined that a fragment comprising multiple pixels will be located with respect to an edge portion between a texture of the first layer of content and the texture of the remaining portion of the multi-layer content and therefore the fragment may be created at a location that that differs from placement at the edge portion.

In some implementations, based on an angle and distance of the user with respect to the display, a single sampling process of the first layer of content may be performed for rendering the view with respect to a final resolution size.

Some implementations render multi-layer content (e.g., Core Animation® content that includes video) that includes a high-res content layer (e.g., for video, images, sidecar content, etc.) and low-res layers (e.g., presenting a surrounding webpage, video player, etc.) within an 3D (e.g., XR) environment. Existing techniques may render a single 2D texture for the multi-layer content (e.g., Core Animation® may be used to preliminarily render a 2D rectangle of content having a consistent resolution) that is then rendered (e.g., by a shader) to appear at a 3D position in a view of the 3D environment. Treating the multi-layer content in this way (i.e., as a single texture) may result in resolution loss, warping, or other defects in the high-resolution layer content. Some implementations disclosed herein separate such high-res layer content (e.g., preserving the relatively high resolution of video or other high-resolution content) from the rest of the multi-layer content for fragment shader rendering (e.g., as separate items rather than a single texture). The other multi-layer content layer may be altered to simplify shader rendering (e.g., to avoid the need for the shader having to use z/depth info to distinguish portions of the high-res/video content that should be visible from low-res/UI content on top of the high-res/video content that should be visible). Specifically, areas of the low-res UI content that are behind the video (e.g., in z depth) may be “punched-out” from the low-res layer so that when the shader renders the low-res content in front of the high-res layer content, appropriate portions of the high-res content are visible (e.g., the video is visible except in places where there are UI elements in front of it). The techniques may be limited to particular circumstances, e.g., where there is no blurred UI-on-video.

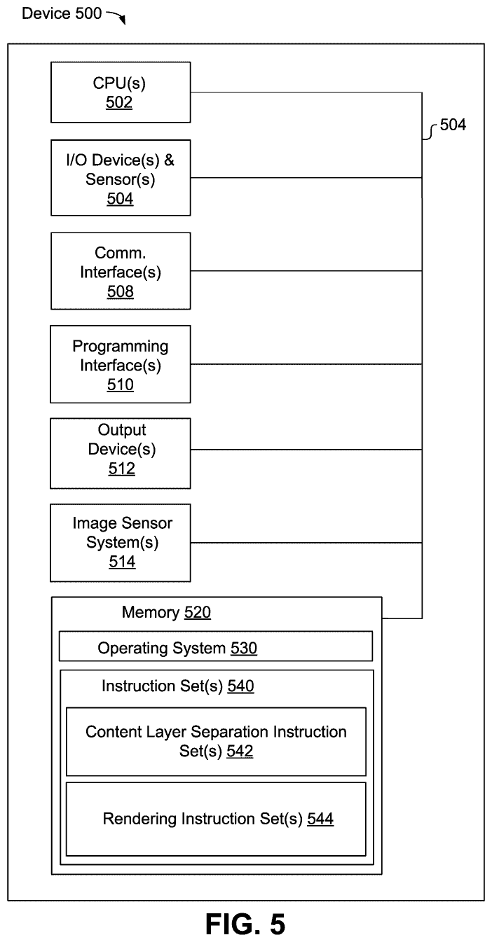

FIG. 5 is a block diagram of an example device 500. Device 500 illustrates an exemplary device configuration for electronic devices 105 and 110 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 504, one or more communication interfaces 508 (e.g., USB, FIREWIRE, THUNDERBOLT, IEEE 802.3x, IEEE 802.11x, IEEE 802.14x, GSM, CDMA, TDMA, GPS, IR, BLUETOOTH, ZIGBEE, SPI, I2C, and/or the like type interface), one or more programming (e.g., I/O) interfaces 510, output devices (e.g., one or more displays) 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), one or more cameras (e.g., inward facing cameras and outward facing cameras of an HMD), one or more infrared sensors, one or more heat map sensors, and/or the like.

In some implementations, the one or more displays 512 are configured to present a view of a physical environment, a graphical environment, an extended reality environment, etc. to the user. In some implementations, the one or more displays 512 are configured to present content (determined based on a determined user/object location of the user within the physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a content layer separation instruction set 542 and a rendering instruction set 544. The instruction set(s) 540 may be embodied as a single software executable or multiple software executables.

The content layer separation instruction set 542 is configured with instructions executable by a processor to separating a layer of content (e.g., video) of multi-layer content to provide a remaining portion of the multi-layer content.

The rendering instruction set 544 is configured with instructions executable by a processor to render a view of a 3D environment that includes a depiction of multi-layer content at a 3D position within the 3D environment.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head mounted device (HMD) having a processor and a display:
obtaining multi-layer content comprising a first layer of content and one or more second layers of content, the first layer of content having a resolution that is different than the one or more of the second layers of content;
separating the first layer of content of the multi-layer content, wherein separating the first layer provides a remaining portion of the multi-layer content;
rendering a texture of the remaining portion of the multi-layer content; and
rendering a view of a 3D environment that includes a depiction of the multi-layer content at a 3D position within the 3D environment, the depiction of the multi-layer content rendered by blending the separated first layer of content and the texture of the remaining portion of the multi-layer content.

2. The method of claim 1, wherein:
in response to determining that a criteria has not been detected, performing said separating the first layer of content.

3. The method of claim 2, wherein the criteria identifies that a blur effect is to be applied on the one or more of the second layers of content covering at least a portion of the first layer.

4. The method of claim 2, wherein the criteria identifies that a portion of the first layer of content has exceeded a boundary of a presentation structure.

5. The method of claim 1, wherein:
in response to determining that a criteria has been detected, rendering a view of the 3D environment with an initial configuration of the multi-layer content occurring prior to said separating.

6. The method of claim 1, further comprising:
based on an angle and distance of the user with respect to the display, performing a single sampling process of the first layer of content for said rendering the view with respect to a final resolution size.

7. The method of claim 1, wherein said separating the first layer of content comprises removing layer content from the one or more second layers, the layer content located behind the first layer of content.

8. The method of claim 7, wherein said removing the layer content from the one or more second layers comprises removing background content located behind the first layer such that content of the first layer will be visible within the view of the 3D environment without a module performing said rendering having to account for depth attributes.

9. The method of claim 7, wherein said rendering the texture comprises compositing the remaining portion into a single texture.

10. The method of claim 7, wherein said rendering the view comprises rendering the content of the one or more second layers in front of the of first layer of content such that appropriate portions of the first layer of content are visible.

11. The method of claim 7, wherein the first layer of content comprises a higher resolution than a resolution of the one or more second layers of content.

12. The method of claim 7, wherein the first layer of content is comprised by a video.

13. The method of claim 7, wherein the one or more second layers of content define UI elements.

14. The method of claim 7, further comprising:
determining that a fragment comprising multiple pixels will be located with respect to an edge portion between a texture of the first layer of content and the texture of the remaining portion of the multi-layer content; and
creating the fragment at a location that that differs from placement at the edge portion.

15. A non-transitory computer-readable medium comprising instructions that when executed by a processor cause the processor to perform operations comprising:
obtaining multi-layer content comprising a first layer of content and one or more second layers of content, the first layer of content having a resolution that is different than the one or more of the second layers of content;
separating the first layer of content of the multi-layer content, wherein separating the first layer provides a remaining portion of the multi-layer content;
rendering a texture of the remaining portion of the multi-layer content; and
rendering a view of a 3D environment that includes a depiction of the multi-layer content at a 3D position within the 3D environment, the depiction of the multi-layer content rendered by blending the separated first layer of content and the texture of the remaining portion of the multi-layer content.

16. A head mounted device (HMD) comprising:
a non-transitory computer-readable storage medium; and
one or more processors coupled to the non-transitory computer-readable storage medium, wherein the non-transitory computer-readable storage medium comprises program instructions that, when executed on the one or more processors, cause the HMD device to perform operations comprising:
obtaining multi-layer content comprising a first layer of content and one or more second layers of content, the first layer of content having a resolution that is different than the one or more of the second layers of content;
separating the first layer of content of the multi-layer content, wherein separating the first layer provides a remaining portion of the multi-layer content;
rendering a texture of the remaining portion of the multi-layer content; and
rendering a view of a 3D environment that includes a depiction of the multi-layer content at a 3D position within the 3D environment, the depiction of the multi-layer content rendered by blending the separated first layer of content and the texture of the remaining portion of the multi-layer content.

17. The HMD of claim 16, wherein:
in response to determining that a criteria has not been detected, performing said separating the first layer of content.

18. The HMD of claim 17, wherein the criteria identifies that a blur effect is to be applied on the one or more of the second layers of content covering at least a portion of the first layer.

19. The HMD of claim 17, wherein the criteria identifies that a portion of the first layer of content (e.g., a portion of a video) has exceeded a boundary of a presentation structure (e.g., has scrolled outside of a window of a media player).

20. The HMD of claim 16, wherein:
in response to determining that a criteria has been detected, rendering a view of the 3D environment with an initial configuration of the multi-layer content occurring prior to said separating.
